(19) United States
(12) Patent Application Publication
(10) Pub. No.: US 2007/0146392 A1
(43) Pub. Date: Jun. 28, 2007

(54) System and method for magnifying and editing objects

(75) Inventors: Steven J. Feldman, Osprey, FL (US); Peter Glen, Venice, FL (US)

Correspondence Address: BROOKS KUSHMAN P.C., 1000 TOWN CENTER, TWENTY-SECOND FLOOR, SOUTHFIELD, MI, 48075, US

(73) Assignee: XCPT, Inc., Venice, FL (US)

(21) Appl. No.: 11/320,131

(22) Filed: Dec. 28, 2005

(51) Int. Cl. G06F 17/00; G09G 5/00

(52) U.S. Cl. 345/660; 715/530; 715/502

(57) ABSTRACT

An electronic method for magnifying and editing an object. The method includes receiving an image area defined as a portion of a workspace or image. The method further includes generating an enlarged image based on the image area selected, and a current zoom level; receiving an instruction for activating an editing mode; activating the editing mode for editing the object through the enlarged image to obtain an edited object and receiving one or more edit instructions for editing the object. In certain embodiments, the method allows a user to view and edit areas of the work space under a simulated magnifying glass.

### BACKGROUND OF THE INVENTION

1. Field of the Invention

One aspect of the present invention relates to a system and method for magnifying and editing objects.

2. Background Art

Computer programs exist that allow a user to view and edit pictures and/or images. Some programs refer to these pictures and/or images as objects. While using these programs, the user may desire to enlarge a portion of an object that cannot be properly viewed and edited at the current viewing scale. For instance, a portion of the object may have intricate detail that is indecipherable to the user unless such portion is enlarged. Many computer programs include functionality to enlarge objects for display on a computer display screen.

For instance, some programs include the ability to adjust a zoom percentage (or zoom factor) upward to generate an enlarged object of the entire original object. In particular cases, when the original object covers the entire display screen, the generated enlarged object does not fit entirely on the display screen, causing only a portion of the enlarged project to be displayed. The user typically uses a move function to shift the displayed portion vertically and/or horizontally to view cropped out portions of the enlarged object, necessitating successive shifting operations to view the entire enlarged object. These additional operations may be objectionable to the user, especially if the user only desires enlargement of a relatively small portion of the object to produce an enlarged object that is sized for display on a single display screen.

In light of the shortcomings of existing zoom features, programs have been devised for magnifying a user-selected portion of an object. One approach includes establishing twin display areas on a display screen. The first display area shows the entire image and the second display area shows an enlarged image of a portion of the entire image. The user designates a region of the image as a portion for enlargement. The user also designates a display frame for displaying the enlarged image. The image enclosed within the region is displayed in an enlarged form in the display frame as the second display area. The second display area is superimposed on the first display area when displayed. Unfortunately, this approach requires the user to select two areas to generate an enlarged region.

In many circumstances, object image workspaces are generated, which are composed of a background object and one or more foreground objects that are superimposed on the background object. Using the twin display area methodology (if the original object contains one or more foreground objects) these foreground objects are displayed in the enlarged region. Disadvantageously, the user cannot edit any of the foreground objects through the display frame. Moreover, the user cannot reveal the portion of the background object concealed by the superimposed foreground object(s) once the enlarged image has been produced.

In light of the foregoing, a method and system is needed for magnifying and editing images. A method and system for magnifying objects is also needed that includes background and foreground viewing modes. What is also needed is a method and system for magnifying and editing objects by selecting a single image area.

### SUMMARY OF THE INVENTION

One aspect of the present invention is a method and system for magnifying and editing images. Another aspect of the present invention is a method and system for magnifying objects that includes background and foreground viewing modes. Another aspect of the present invention is a method and system for magnifying objects by selecting a single image area. In certain embodiments, the systems and methods of the present invention can be implemented through a computer program.

According to one embodiment of the present invention, an electronic method for magnifying and/or editing object is disclosed. The electronic method can also be used to magnify and/or edit a predetermined area of a workspace.

The method includes receiving an image area defined as a portion of an object or document; generating an enlarged image based on the image area and a zoom level; receiving an instruction for activating an editing mode; activating the editing mode for editing the object through the enlarged image to obtain an edited object and receiving one or more edit instructions for editing the object.

According to another embodiment of the present invention, an electronic method for magnifying an object is disclosed. The electronic method can also be used to magnify a predetermined area of a workspace.

The method includes the steps of: selecting an image area defined as a portion of an object or a document; generating an area for enlargement based on the image area and a predetermined zoom level; generating an enlarged image of the area for enlargement based on the predetermined zoom level; and displaying the enlarged image superimposed on the object.

According to yet another embodiment of the present invention, an electronic method for magnifying an object is disclosed. The electronic method can also be used to magnify a predetermined area of a workspace.

The object includes a background object and zero or more foreground objects. The method includes the steps of: receiving an image area defined as a portion of an object or a document; receiving a viewing mode selected from the group consisting of a background viewing mode and a foreground viewing mode; and generating an enlarged image based on the image area, the viewing mode and a predetermined zoom level.

According to another embodiment of the present invention, a computer system including a computer display for displaying an object that can be magnified is disclosed. The computer system includes a computer having a central processing unit (CPU) for executing machine instructions and a memory for storing machine instructions that are to be executed by the CPU. The object includes a background object and zero or more foreground objects. The machine instructions when executed by the CPU implement the following functions: receiving an image area defined as a portion of an object; receiving a viewing mode; and generating an enlarged image based on the image area, the viewing mode and a predetermined zoom level.

### BRIEF DESCRIPTION OF THE DRAWINGS

The features of the present invention which are believed to be novel are set forth with particularity in the appended claims. The present invention, both as to its organization and manner of operation, together with further objects, features and advantages thereof, may best be understood with reference to the following description, taken in connection with the accompanying drawings:

FIG. 1 is an environment, i.e. a computer system, suitable for implementing one or more embodiments of the present invention;

FIG. 2a is a flowchart depicting the steps of a method according to one embodiment of the present invention;

FIG. 2b is a flowchart depicting the steps for generating an enlarged image according to one embodiment of the present invention;

FIG. 2c is a flowchart depicting the steps for selecting the viewing mode according to one embodiment of the present invention;

FIG. 2d is a flowchart depicting the steps for editing an enlarged image according to one embodiment of the present invention;

FIG. 2e is a flowchart depicting the steps for moving an image area according to one embodiment of the present invention;

FIG. 3 is a fragment of a display showing an image area and an area for enlargement according to one embodiment of the present invention;

FIG. 4 is an example of an enlarged image generated in background viewing mode according to one embodiment of the present invention;

FIG. 5 is an example of an enlarged image generated in foreground viewing mode according to one embodiment of the present invention;

FIG. 6 is an example of a movement in the image area according to one embodiment of the present invention;

FIG. 7 depicts a display of a dental image according to one embodiment of the present invention;

FIG. 8 depicts an enlarged area displayed in background viewing mode in the context of a dental application of the present invention;

FIG. 9 depicts an enlarged area displayed in foreground viewing mode in the context of a dental application of the present invention; and

FIGS. 10 and 11 depict an example of the editing mode in the context of a dental application of the present invention.

### DETAILED DESCRIPTION OF EMBODIMENTS OF THE PRESENT INVENTION

The words used in the specification are words of description rather than limitation.

“Drag” can refer to the user selecting an object on a display screen, clicking on the object by pressing and holding the mouse button. While the mouse button is down, moving the mouse to a different location constitutes a “drag”. The “drag” ends with the release of the mouse button.

“Object” can mean any user manipulated image, drawing or text, that is part of a document.

“Select” can mean the act of selecting an object. In one embodiment, the user selects an object by moving the mouse cursor on top of the object, and while the cursor is inside the object boundaries, the user clicks the mouse button by pressing it and immediately releasing it.

“User interface” can mean any user manipulated menu, text, button, drawing, or image, that is part of an application or operating system as opposed to part of the document.

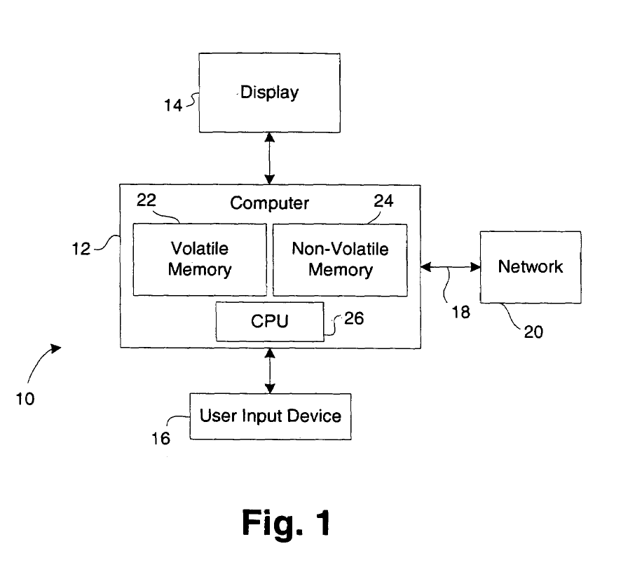

FIG. 1 depicts an environment, computer system 10, suitable for implementing one or more embodiments of the present invention. Computer system 10 includes computer 12, display 14, user interface 16, communication line 18 and network 20.

Computer 12 includes volatile memory 22, non-volatile memory 24 and central processing unit (CPU) 26. Non-limiting examples of non-volatile memory include hard drives, floppy drives, CD and DVD drives, and flash memory, whether internal external, or removable. Volatile memory 22 and/or non-volatile memory 24 can be configured to store machine instructions. CPU 26 can be configured to execute machine instructions to implement functions of the present invention, for example, the viewing and editing of objects, images and pictures, otherwise referred to as objects. In certain embodiments, the collection of images, pictures and/or objects may be referred to as “image workspace”, or “image document” of “document”.

Display 14 can be utilized by the user of the computer 12 to view, edit, and/or magnify objects. A non-limiting example display 14 is a color display, e.g. a liquid crystal display (LCD) monitor or cathode ray tube (CRT) monitor.

The user input device 16 can be utilized by a user to input instructions to be received by computer 12. The instructions can be instructions for viewing and editing objects. The user input device 16 can be a keyboard having a number of input keys, a mouse having one or more mouse buttons, a touchpad or a trackball or combinations thereof. In certain embodiments, the mouse has a left mouse button and a right mouse button. It will be appreciated that the display 14 and user input device 16 can be the same device, for example, a touch-sensitive screen.

Computer 12 can be configured to be interconnected to network 20, the rough communication line 18, for example, a local area network (LAN) or wide area network (WAN), through a variety of interfaces, including, but not limited to dial-in connections, cable modems, high-speed lines, and hybrids thereof. Firewalls can be connected in the communication path to protect certain parts of the network from hostile and/or unauthorized use.

Computer 12 can support TCP/IP protocol which has input and access capabilities via two-way communication lines 18. The communication lines can be an intranet-adaptable communication line, for example, a dedicated line, a satellite link, an Ethernet link, a public telephone network, a private telephone network, and hybrids thereof. The communication lines can also be intranet-adaptable. Examples of suitable communication lines include, but are not limited to, public telephone networks, public cable networks, and hybrids thereof.

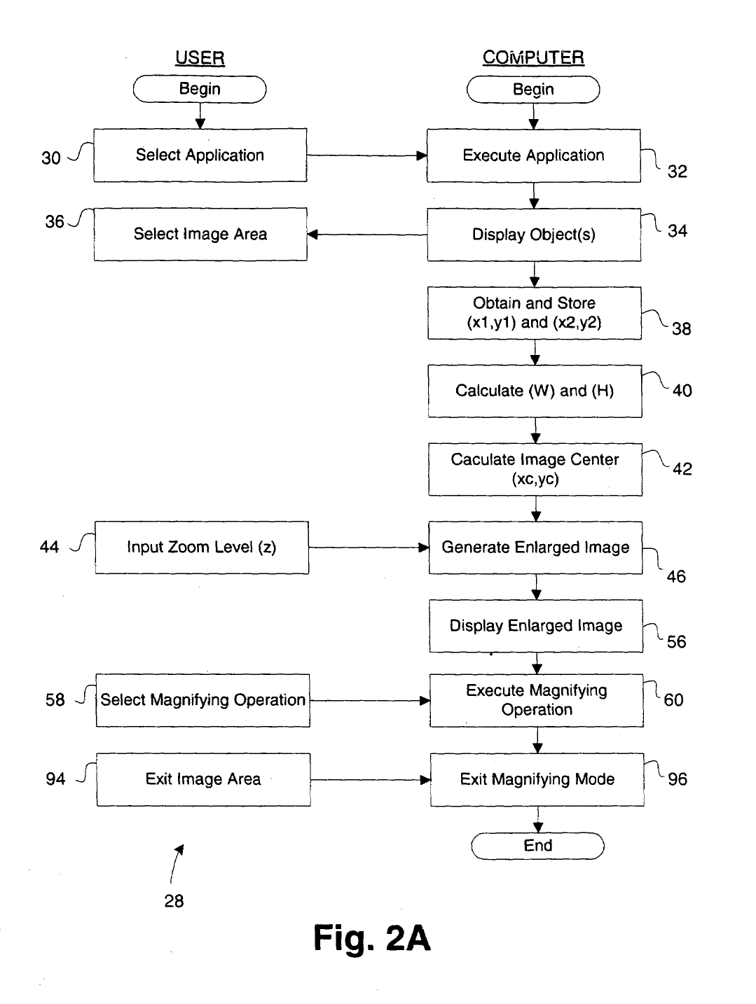

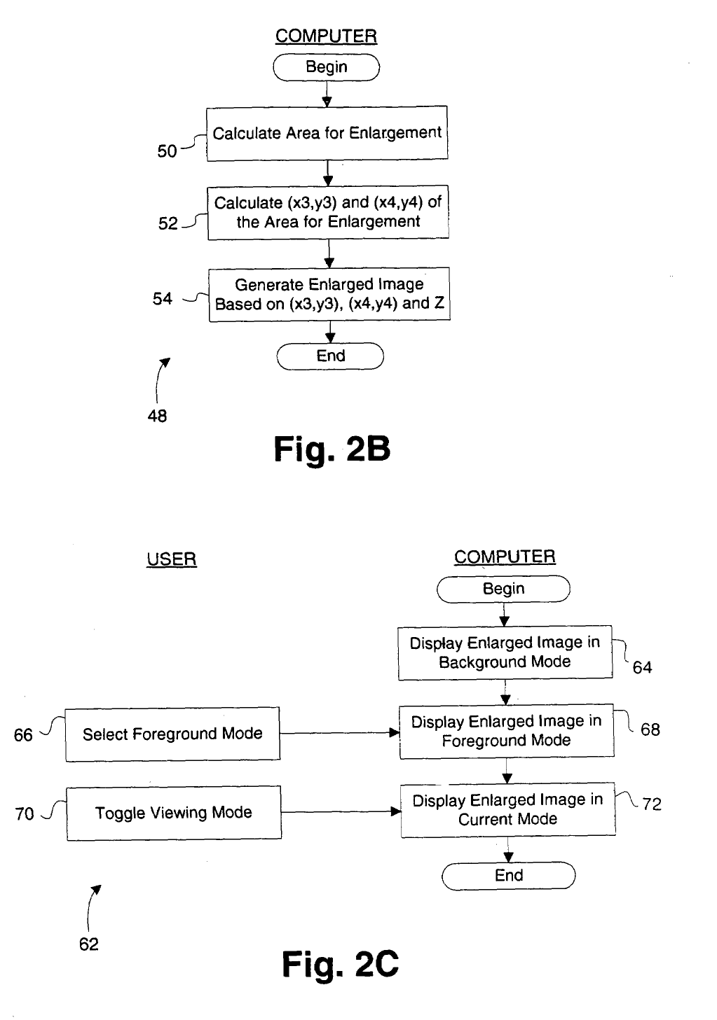

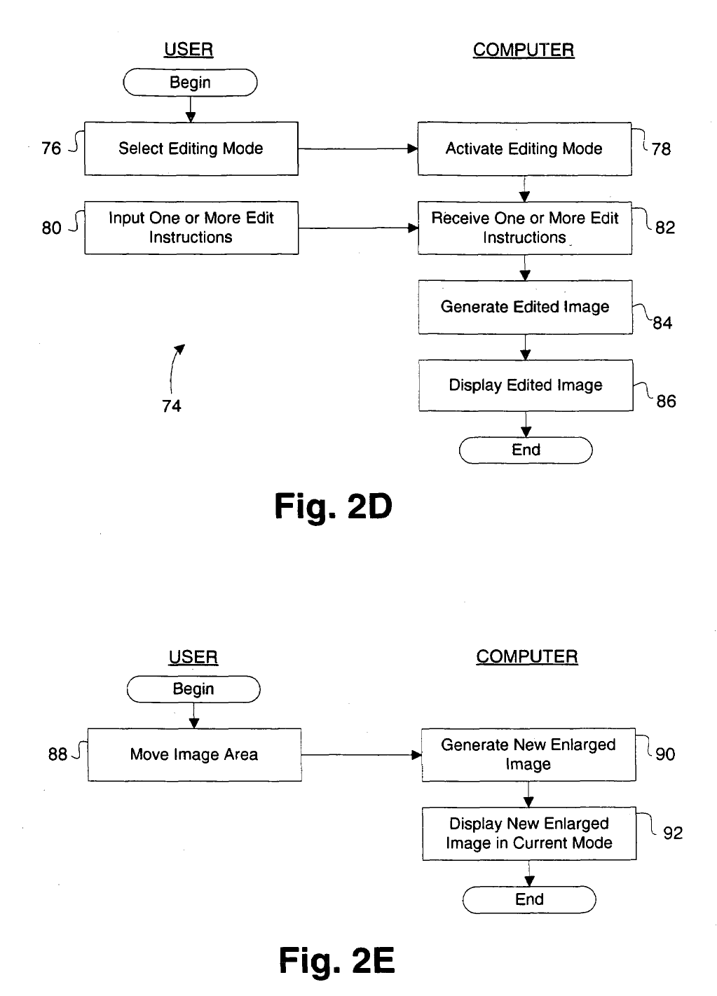

A computer user can utilize computer system 10 to magnify and edit objects. FIGS. 2a and 2b are a flowchart 28 depicting user steps and computer steps for implementing one or more methods of the present invention. It should be understood that the steps of FIG. 2a and 2b can be rearranged, revised and/or omitted, and any step can be carried out by a user, a computer or in combination according to the particular implementation of the present invention.

According to block 30, a user selects an application, for instance, a computer program, for execution on computer 12. In turn, computer 12 executes the computer program, as depicted in block 32. In certain embodiments, the computer program includes functionality for storing objects to volatile memory 22 and/or non-volatile memory 24 and displaying objects on display 14 for viewing and editing by the user.

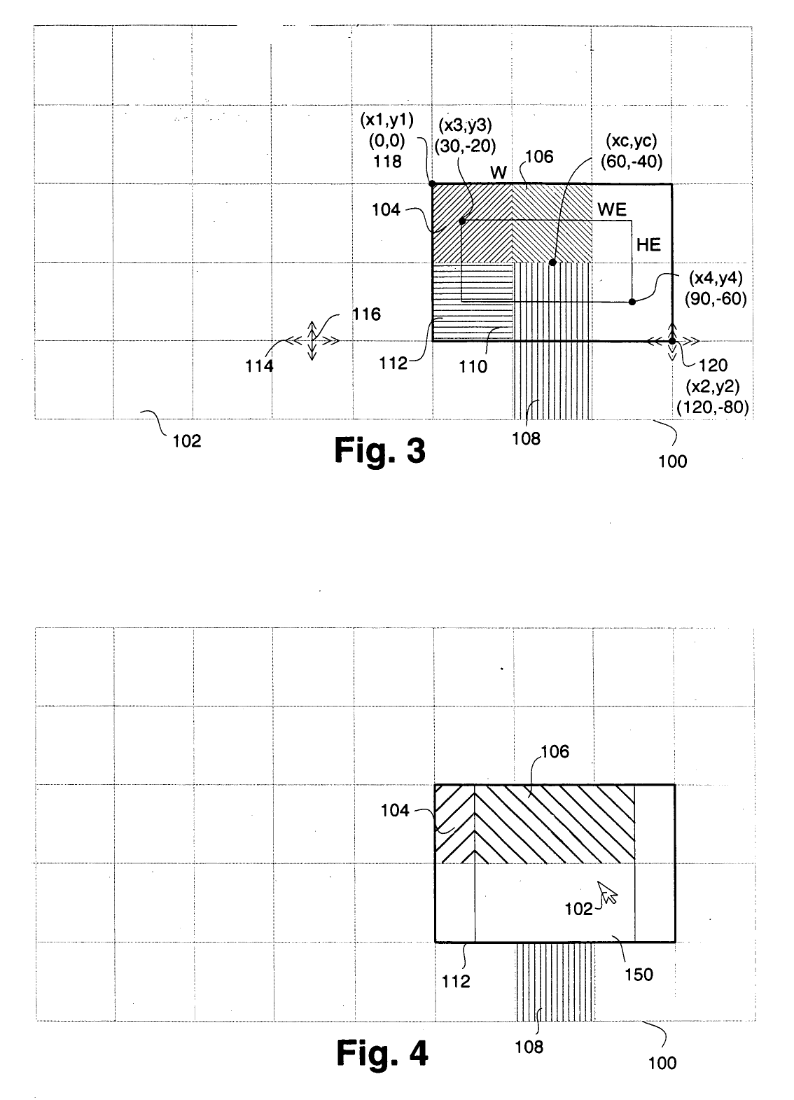

According to block 34, one or more objects are displayed on display 14. It should be understood that CPU 26 can execute machine instructions for displaying one or more objects on display 14. FIG. 3 is a portion 100 of display 14 for displaying objects that can be viewed by the user. Portion 100 includes a background object 102, otherwise referred to herein as a canvas, which includes a grid system and square objects 104 and 106. Portion 100 also includes rectangular foreground object 108 and square foreground object 110, each having a different pattern.

It should be appreciated that the canvas and foreground objects of FIG. 3 are one example of the objects that can viewed by utilizing the present invention. In certain embodiments, the canvas is an unmodifiable object that acts as the foundation for superimposition of foreground images. In dental applications, the canvas can be a digital photograph of the patient or an X-ray image of the patient's mouth.

In certain embodiments, the user desires to magnify portion 100 to enhance the user's ability to view and manipulate the displayed objects. According to block 36 and FIG. 3, the user selects an image area 112 with a mouse. The user moves crosshair 114 with the mouse from location 116 to location 118. It should be understood that position indications other than crosshairs can be utilized, for example, pointers, cursors, markers, etc. Location 118 is a first boundary location (x1,y1) of image area 112. The user then clicks and holds down a mouse button on the mouse, and drags crosshair 114 from location 118 to location 120. Location 120 is a second boundary location (x2,y2) of image area 112. As the crosshair 114 drags from location 118 to location 120, a rectangular outline defined by (x1,y1) and the current crosshair location is displayed on display 14, allowing the user to visualize the size and shape of the image area before it is defined by releasing the mouse button when the crosshair reaches location 120. The crosshair movement depicted in FIG. 3 generates a image area by moving the crosshair from the top-left corner to the bottom-right corner of the resulting image area 112. It should be understood that other cursor movements, i.e. top-right to bottom-left, bottom-right to top-left, or bottom-left to top-right, can be utilized to define the image area.

Once the image area is defined, the (x1,y1) and (x2,y2) coordinates are obtained by machine instructions executed by CPU 26 and stored in memory 22 and/or 24, as depicted in block 38. In FIG. 3, (x1,y1) and (x2,y2) are defined in the same coordinate system, wherein (x1,y1) is defined as the origin of the system and (x2,y2) equals (120,−80). In this example, (x1,y1) is defined by the origin of a local coordinate system. It should be appreciated that other coordinate systems, for example, a universal coordinate system, can be used for defining coordinate locations. The units of the coordinate system are pixels, although metric or English units can be utilized according to the particular implementation of the present invention.

The values of (x1,y1) and (x2,y2) are used to calculate the width (W) and (H) dimensions of the image area 112 (block 40), via the following equations:

W=|x2−x1| (1)

H=|y2−y1| (2)

Using equation (1), (W) is calculated by subtracting 120 pixels from 0 pixels and then calculating the absolute value of the subtraction, thereby generating a value of 120 pixels for (W). Using equation (2), (H) is calculated by subtracting −80 pixels from 0 pixels and then calculating the absolute value of the subtraction, thereby generating a value of 80 pixels for (H).

In block 42, the image area center (xc,yc) is calculated. (xc,yc) is utilized to center an enlarged image in the image area 112. The values of (x1,y1) and (x2,y2) are used to calculate the image area center (xc,yc), via the following equations:

xc=(x2−x1)/2 (3)

yc=(y2−y1)/2 (4)

### Using equations (3) and (4), (xc) equals (120−0)/2, i.e. 60 and (yc) equals (−80−0)/2, i.e. −40.

In block 44, the user can enter a zoom level (Z) for magnifying the image area 112. For instance, the zoom level can be input by the user through a pop-up window. In other embodiments, the user can click on a mouse button to increment or decrement the zoom level by a pre-determined percentage. Alternatively, the computer program can have a default zoom level setting. Moreover, a second image area can be selected at least partially within the first image area to increase the zoom level of the first image area by the zoom level of the second image area.

According to the present example, the default zoom level is 2:1, or 200%. It should be appreciated that the present invention can be practiced over a range of zoom levels. In certain embodiments, the range of applicable zoom levels is 1.1:1 to 100:1.

In block 46, the enlarged image is generated based on (W), (H), (xc,yc) and zoom level (Z %). In certain embodiments, (xc,yc) serves as the center, otherwise referred to as the anchor, of the image area 112, the area for enlargement, and the enlarged image area. It should be appreciated that the enlarged image can be generated using other combinations which define the area for enlargement, for example, (x1,y1) and (x2,y2), instead of (W), (H) and (xc,yc). Using this example, the (xc,yc) values can be substituted in terms of (x1,y1) and (x2,y2) into equations (7)-(10).

FIG. 2b is a flowchart 48 illustrating the steps for generating an enlarged image. In block 48, an area for enlargement is calculated, which acts as the area that is enlarged to the boundaries of image area 112. The following equations can be used to calculate the height (HE) and width (WE) dimensions for the area for enlargement:

HE=H/(Z %/100%) (5)

WE=W/(Z %/100%) (6)

### Using equations (5) and (6), (HE) equals 80/(200%/100%), i.e. 40 and (WE) equals 120/(200%/100%), i.e 60.

In block 52, the boundary locations (x3,y3) and (x4,y4) of the area for enlargement are calculated. (x3,y3) represents the upper-left corner of the area for enlargement and (x4,y4) represents the lower-right corner of the area for enlargement, although other coordinate pairs can be utilized to define the boundaries of the area for enlargement, e.g. lower-left corner and upper-right corner. (x3,y3) and (x4,y4) can be calculated using the following equations:

x3=xc−(WE/2) (7)

y3=yc+(HE/2) (8)

x4=xc+(WE/2) (9)

y4=yc−(HE/2) (10)

Using equations (7) and (8), (x3) equals 60−(60/2), i.e. 30 and (y3) equals −40+(40/2), i.e. −20. Using equations (9) and (10), (x4) equals 60+(60/2), i.e. 90 and (y4) equals −40−(40/2), i.e. −60. Therefore, (x3,y3) and (x4,y4) equal (30,−20) and (90,−60), respectively. In certain embodiments, the area for enlargement is centered on (xc,yc) for the purposes of calculating the boundary locations.

In block 54, the zoom level (Z %) is applied to the area for enlargement as defined by (x3, y3) and (x4, y4) to generate an enlarged image of the background and foreground objects (when selected) in the area for enlargement. Alternatively, (WE), (HE) and (xc,yc) can also be used to generate the enlarge image. In certain embodiments, the enlarged image is sized to fit image area 112, although the enlarged image area can be greater than or less than the image area. The enlarged image data can be stored in memory 22 and/or 24.

In block 56, the enlarged image is displayed. FIG. 4 is an example of enlarged image 150 displayed on fragment 100 of display 14. According to FIG. 4, the enlarged image is displayed in a background viewing mode, which displays the enlarged image without any foreground objects. As such, foreground objects 108 and 110 are not displayed on fragment 100. Advantageously, the background mode allows the user to obtain an enlarged view of the background area under foreground objects 108 and 110. In this example, the background mode is set as the default by the computer program. In alternative embodiments, a foreground mode (discussed below) can be set as the default. Moreover, the viewing mode can be selected by the user through a pull-down menu or pop-up menu, or any suitable user interface elements.

In block 58, the user can select a magnifying operation. Non-limiting examples of magnifying operations are viewing mode selection (FIG. 2C), editing mode (FIG. 2D), and image area movement (FIG. 2E). In block 60, the user selected magnifying operation is executed by the computer 12.

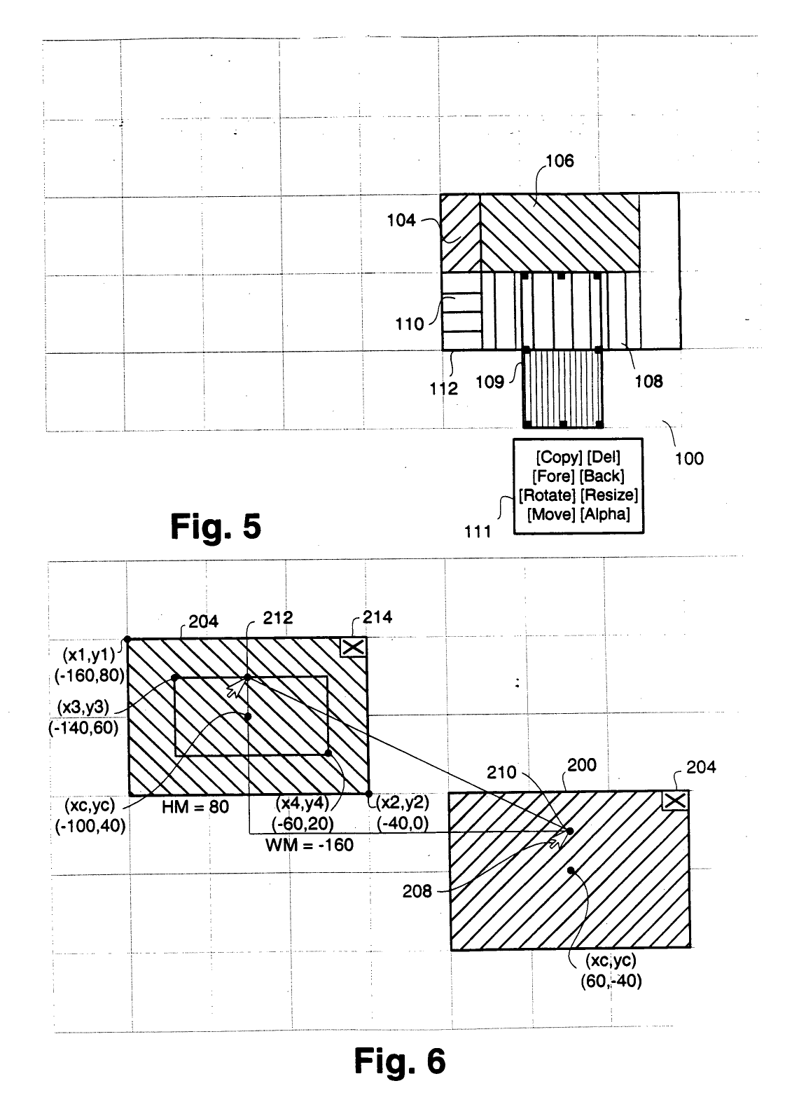

Moving to FIG. 2c, the user can select a viewing mode for the image area, as depicted by flowchart 62. According to block 64, the enlarged image is displayed in the background viewing mode. In this particular embodiment, the user can switch between the background mode and the foreground mode by double-clicking on a mouse button while cursor 152 is within image area 112 (block 66). In the foreground mode, foreground objects are superimposed on the background objects. FIG. 5 is an example of fragment 100 of display 14 which displays foreground objects 108 and 110 and a portion of background object 100, including objects 104 and 106 within image area 112 (block 68). Advantageously, the foreground mode allows the user to obtain an enlarged view of foreground objects superimposed on the background object.

According to block 70, the user can toggle between viewing modes. In certain embodiments, the user can double-click on the image area 112 to switch from one viewing mode to the other, thereby switching the current mode. The enlarged image can be automatically displayed in the new viewing mode, as depicted in block 72. Advantageously, the user can successively double click on the image area 112 to toggle back and forth between viewing modes.

FIG. 2d illustrates flowchart 74 including steps associated with the editing mode. According to block 76, the user can select an editing mode for editing the enlarged image. In certain embodiments, the editing mode can be selected by clicking on the right mouse button while the mouse cursor is within the image area 112. In other embodiments, a list menu can be used to select the editing mode. For example, the user can right-click on the image area 112, and in response, a list menu can be displayed. The list menu can include a layer ordering option and a “send object to background” sub-option. The user can select the editing mode by selecting this option and then the sub-option.

According to block 78, the editing mode is activated upon the user selection. In the editing mode, the user can select foreground images within the boundaries of the image area 112 for editing. For example, the user can select rectangular foreground object 108. FIG. 5 depicts a rectangular outline 109 which appears around the original size of the foreground object 108 when the user selects it while in editing mode. In addition, an object menu 111 is also displayed on display 14 along with the rectangular outline 109. Object menu 111 can include a number of editing options, including but not limited to [copy], [del], [fore], [back], [rotate], [resize], [move] and [alpha] options. The [copy] option can be used to generate a copy of the selected object. The [del] option can be used to delete the selected object. The [fore] option can be used to reorder the object's display order (otherwise referred to as the Z-order), so the object appears on top of the other objects. The [back] option can be used to reorder the object's Z-order so the object appears below all of the other objects, but not below the canvas. The [rotate] option can be used to rotate the selected object. The [move] option can be used to move the selected object. The [alpha] object can be used to change the alpha blending selected factor, and adaptively alpha blending threshold. It should be appreciated that these are examples of the editing functions that can be carried out by the user within the editing mode, other editing functions can be used without departing from the scope of the invention.

Once an object is activated for editing, the user can input one or more editing instructions, e.g. [copy], [alpha], etc. (block 80). These editing instructions are received by computer 12 (block 82). In block 84, computer 12 generated an edited imaged based on the editing instructions. The edited image can be displayed on display 14 (block 86). Advantageously, while the selected object is being edited, the results may be displayed in real-time within the image area 112 and outside the boundaries of the image area 112.

According to block 88, the image area can be moved within display 14. In certain embodiments, the user can click on an image area displaying an enlarged image and drag the image area to another location on display 14. As the user drags the mouse, a new enlarged image is automatically generated and displayed within a new image area, thereby giving the user a live update of the new enlarged area. The new enlarged image is an enlargement of a portion of the object(s) in the new image area based on the current zoom level (Z). The new image area has the same W, H, WA and HA values. The new enlarged image is generated using the same zoom level (Z), however, the coordinates (x1,y1), (x2,y2), (x3,y3), (x4,y4), and (xc,yc) are recalculated based on the cursor movement, or new cursor position. The cursor movement can be represented as a change in the x direction (dx) and a change in the y direction (dy) relative to the starting location of the cursor. The units for dx and dy can be pixels, although other units, for example, inches or millimeters, can be used in accordance with the present invention.

FIG. 6 is an example of a cursor movement for moving first image area 200 to a second image area 204. The image area can be updated automatically and in real-time according to the cursor movement. Therefore, from the user's perspective, the cursor movement is similar to moving a magnifying glass across a paper document.

Cursor 208 moves from a first location 210, which is represented as (60,−20) in the coordinate system used above, to a second location 212, which is represented as (−100,60) in the same coordinate system, thereby producing a cursor movement height (HM) of 80 and a width (WM) of −160. The (HM) and (WM) values are applied to (xc,yc) to calculate a new (xc,yc), which can be represented by the following equations:

new xc=xc+WM (11)

new yc=yc+HM (12)

Using equations (11) and (12), new xc equals 60−160, i.e. −100 and new yc equals −40+80, i.e. 40. The new (xc,yc), W and H are used to calculate the new values for (x1,y1) and (x2,y2), for example, via the following equations:

new x1=new xc−W/2 (13)

new y1=new xy+H/2 (14)

new x2=new xc+W/2 (15)

new y2=new yc−H/2 (16)

### Using equations (13) and (14), the new (x1,y1) equals (−100−120/2,40+80/2), i.e. (−160,80). Using equations (15) and (16), the new (x2,y2) equals (−100+120/2,40−80/2), i.e. (−40,0).

The new (xc,yc), WE and HE are used to calculate new values for (x3,y3) and (x4,y4), for example, via the following equations:

new x3=new xc−WE/2 (17)

new y3=new xy+HE/2 (18)

new x4=new xc+WE/2 (19)

new y4=new yc−HE/2 (20)

### Using equations (17) and (18), the new (x3,y3) equals (−100−80/2,40+40/2), i.e. (−140,60). Using equations (19) and (20), the new (x4,y4) equals (−100+80/2,40−40/2), i.e. (−60,20).

According to block 90, the new enlarged area is generated using the new coordinate values, i.e. the objects (depending on the current viewing mode) within the boundaries (x3,y3) and (x4,y4) are enlarged by Z to fit in second image area 204. According to block 92, the new enlarged image is displayed in the current mode.

In the example depicted in FIG. 6, first and second image areas 200 and 204 contain foreground images since the viewing mode is the foreground mode. It should be appreciated that the display 14 can be in background viewing mode while the image area is being moved. The user can also execute a first cursor movement in one mode, then toggle to the other mode, and then execute a second cursor movement in the other mode. The features of toggling between modes in combination with moving the image area can be used to efficiently differentiate and view foreground objects and the areas below superimposed foreground objects.

According to block 94, the user can exit the image area. In certain embodiments, an exit icon 214 is generated in the upper-right corner of the image area. The user can single click on the exit icon 214, to exit the image area, thereby exiting the magnifying mode (block 96).

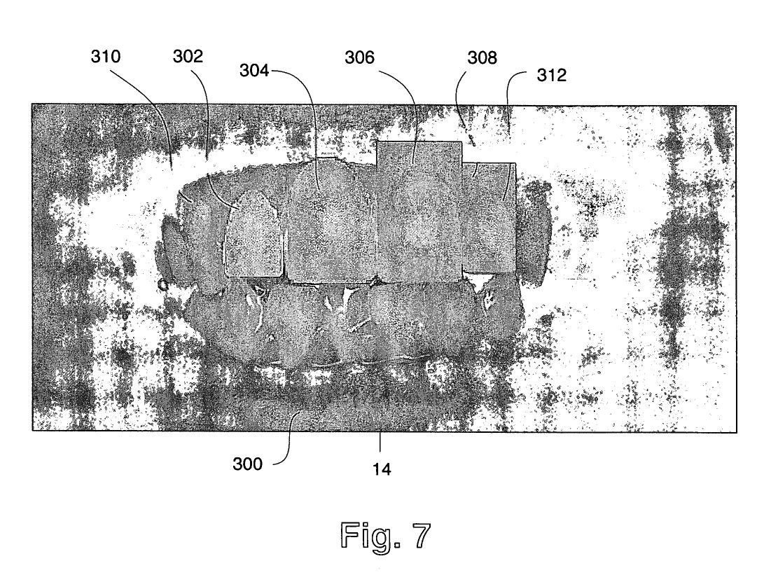

Turning now to FIGS. 7 through 11, an example of a dental application of a process of the present invention is disclosed. In this example, a picture 300 of a patient's mouth is shown on display 14. Picture 300 is shown as the canvas of display 14. Dental prosthetic images 302, 304, 306 and 308 are shown in the foreground of display 14. Picture 300 includes the patient's gum line 310. A portion of gum line 310 is obscured by the dental prosthetic images 302, 304, 306 and 308. The patient may desire to view a magnified comparison of the patient's existing gum line and a proposed gum line 312 produced by dental prosthetic images 302, 304, 306 and 308. Therefore, it is desired to magnify a portion of the picture 300 and dental prosthetic images 302, 304, 306 and 308.

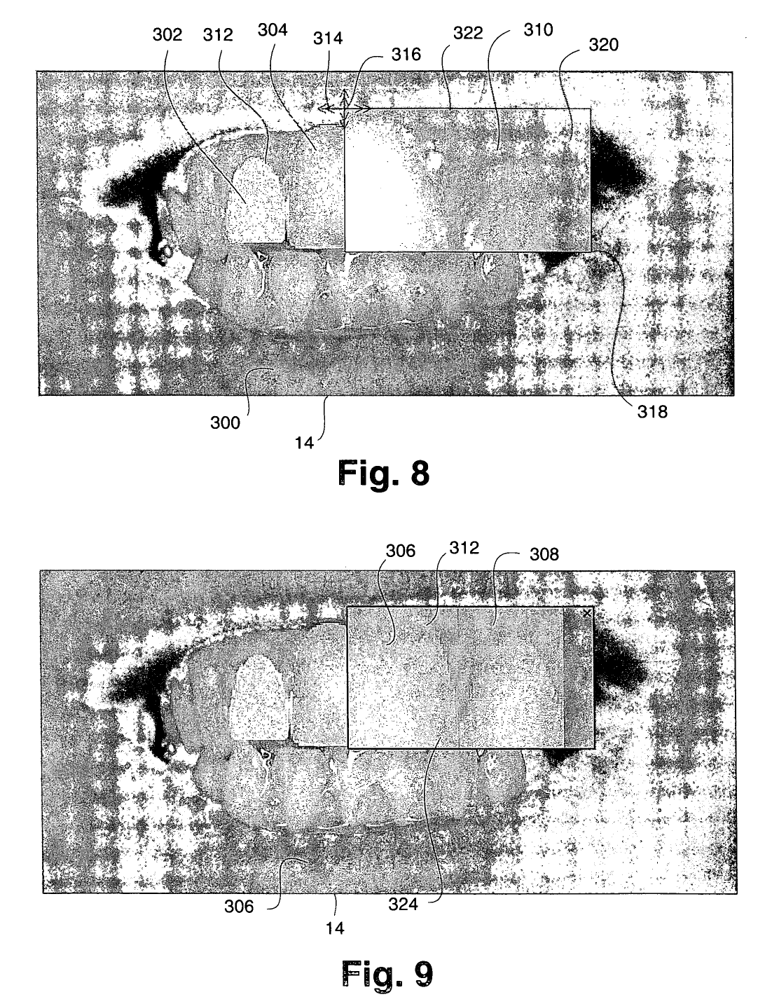

To do so, according to FIG. 8, the user first moves a crosshair 314 to a first location 316 on display 14, and then the user holds down a mouse button and drags crosshair 314 to a second location 318 to produce an image area 322. Once the user releases the mouse button while at the second location 318, an enlarged image 320 is generated and displayed within image area 322. According to this example, the current mode is background viewing mode, therefore only a portion of the picture 300 is displayed within image area 322. Advantageously, in the background viewing mode, the user and/or patient can view an enlarged image of the patient's current gum line 310.

The user can select the foreground viewing mode by double-clicking on a mouse button. FIG. 9 is an example of enlarged image 324 in foreground viewing mode. Enlarged image 324 includes portions of dental prosthetic images 306 and 308 and the proposed gum line 312. The user and/or patient can view an enlarged image of the patient's proposed gum line 312.

The user can also click on image area 322 and drag the cursor to generate a new image area. According to the current zoom level, a portion of the new image area is enlarged to generate the new enlarged image, which is displayed within the new image area. It should be appreciated that the multiple cursor movements can be used to generate successive new enlarged images.

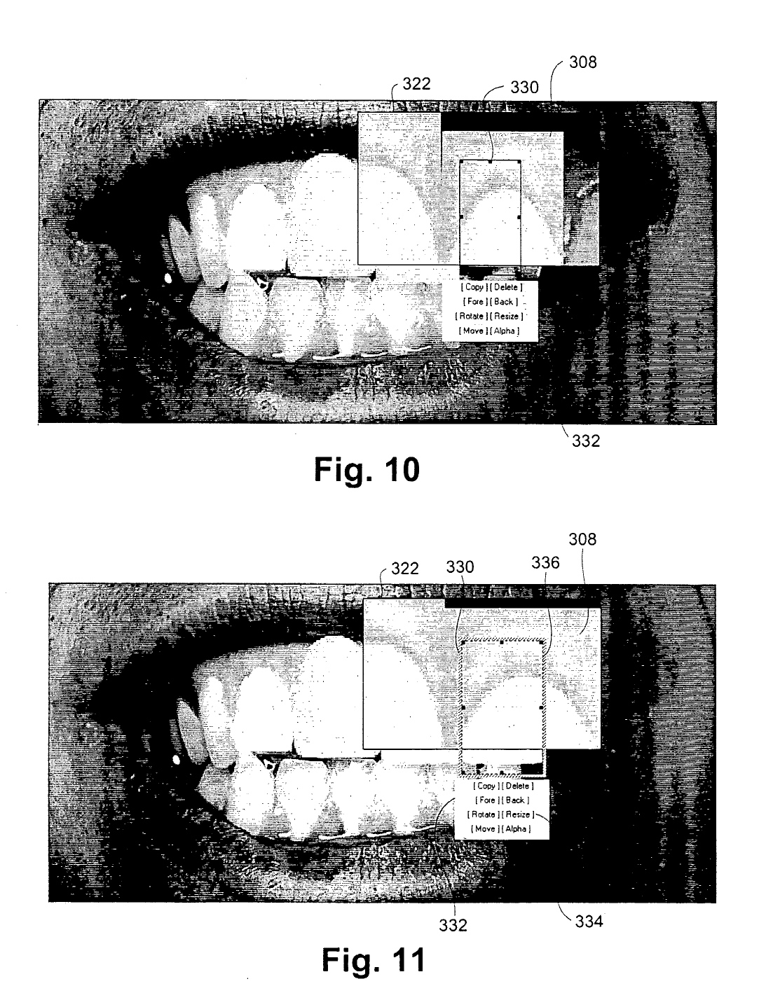

FIGS. 10 and 11 illustrate an example of the editing mode of certain embodiments of the present invention as applied to a dental image. While in foreground viewing mode, the user can select the editing mode by clicking on the right mouse button, thereby triggering the display of a list menu having an option for activating the editing mode. Once activated, the user can select a foreground object within image area 322 for editing.

According to FIGS. 10 and 11, the user selects dental prosthetic image 308 for editing, thereby generating rectangular outline 330. The user can select image 308 by a single click of the left mouse button, although other input can be used to select an enlarged image for editing. Upon selecting image 308, object menu 332 is displayed. Menu 332 includes a number of editing functions that can be performed on image 308.

As illustrated in FIG. 11, the user selects the [resize] option 334 for re-sizing image 332, thereby generating a shaded rectangular outline 336. As the user re-sizes image 308, the re-sizing is automatically generated and displayed within image area 322 and outside of image area 322. Therefore, the user and patient can obtain real-time feedback regarding edits in an enlarged image area.

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An electronic method for magnifying and editing an object, the method comprising the steps of:
(a) receiving an image area defined as a portion of an object;
(b) generating an enlarged image based on the image area and a zoom level;
(c) receiving an instruction for activating an editing mode;
(d) activating the editing mode for editing the object through the enlarged image to obtain an edited object; and
(e) receiving one or more edit instructions for editing the object.

2. The electronic method of claim 1 further comprising:
(f) generating the edited and magnified object based on the one or more edit instructions.

3. The electronic method of claim 2 further comprising:
(g) displaying the edited and magnified object.

4. The electronic method of claim 3, wherein steps (f) and (g) comprise
(f) automatically generating the edited and magnified object upon receiving the one or more edit instructions; and
(g) automatically displaying the edited and magnified object upon generation.

5. The electronic method of claim 3 wherein step (g) comprises:
(g) displaying at least a portion of the edited and magnified object as an enlarged edited image within the image area.

6. The electronic method of claim 1, wherein the one or more edit instructions are selected from the group consisting of: copy, delete, re-size, and blend.

7. An electronic method for magnifying an object, the method comprising the steps of:
(a) selecting an image area defined as a portion of an object;
(b) generating an area for enlargement based on the image area and a predetermined zoom level;
(c) generating an enlarged image of the area for enlargement based on the predetermined zoom level; and
(d) displaying the enlarged image superimposed on the object.

8. The electronic method of claim 7, wherein steps (b),(c) and (d) are carried out automatically in response to the execution of step (a).

9. The electronic method of claim 7, wherein the enlarged image is the same size and shape as the image area, and the enlarged image is displayed within the image area.

10. The electronic method of claim 7, further comprising:
(e) receiving a viewing mode selected from the group consisting of a background viewing mode and a foreground viewing mode, wherein the object includes a background object and one or more foreground objects.

11. The electronic method of claim 9, wherein step (c) includes:
(c1) if the viewing mode is the background viewing mode, generating an enlarged image of solely the background object within the area of enlargement based on the predetermined zoom level; and
(c2) if the viewing mode is the foreground viewing mode, generating an enlarged image of the background object and the foreground objects within the area of enlargement based on the predetermined zoom level.

12. The electronic method of claim 7, further comprising:
(e) selecting a new image area by clicking on a cursor in the existing image area and dragging the cursor to define the new image area.

13. The electronic method of claim 12, further comprising:
(f) repeating steps (b), (c) and (d) based on the new image area.

14. The electronic method of claim 13, further comprising:
(g) repeating steps (e) and (f) at least two times.

15. An electronic method for magnifying an object, the method comprising the steps of:
(a) receiving an image area defined as a portion of an object;
(b) receiving a viewing mode selected from the group consisting of a background viewing mode and a foreground viewing mode, wherein the object includes a background object and zero or more foreground objects; and
(c) generating an enlarged image based on the image area, the viewing mode and a predetermined zoom level.

16. The electronic method of claim 15, further comprising:
(d) displaying the enlarged image.

17. The electronic method of claim 16, wherein steps (c) and (d) are carried out automatically in response to the execution of step (a).

18. The electronic method of claim 16, wherein steps (c) and (d) are carried out automatically in response to the execution of step (b).

19. The electronic method of claim 15, wherein step (c) includes:
(c1) if the viewing mode is the background viewing mode, generating an enlarged image of solely the background object within the area of enlargement based on the predetermined zoom level; and
(c2) if the viewing mode is the foreground viewing mode, generating an enlarged image of the background object and the foreground objects within the area of enlargement based on the predetermined zoom level.

20. The electronic method of claim 16, further comprising:
(e) selecting a new image area by clicking on a cursor in the existing image area and dragging the cursor to define the new image area.

21. The electronic method of claim 20, further comprising:
(f) repeating steps (c) and (d) based on the new image area.

22. The electronic method of claim 21, further comprising:
(g) repeating steps (e) and (f) at least two times.

23. A computer system including a computer display for displaying an object that can be magnified, the computer system comprising:
a computer having a central processing unit (CPU) for executing machine instructions and a memory for storing machine instructions that are to be executed by the CPU, the machine instructions when executed by the CPU implement the following functions:
(a) receiving an image area defined as a portion of an object;
(b) receiving a viewing mode selected from the group consisting of a background viewing mode and a foreground viewing mode, wherein the object includes a background object and zero or more foreground objects; and
(c) generating an enlarged image based on the image area, the viewing mode and a predetermined zoom level.
